(19) United States
(12) Patent Application Publication
(10) Pub. No.: US 2026/0157289 A1
(43) Pub. Date: Jun. 11, 2026

(54) TOOL CONTROL SYSTEM FOR WORK VEHICLE

(71) Applicant: Komatsu America Corp., Chicago, IL (US)

(72) Inventor: Jeffrey Bertrand HUNTINGTON, Shawano, WI (US)

(21) Appl. No.: 19/181,764

(22) Filed: Apr. 17, 2025

Related U.S. Application Data
(60) Provisional application No. 63/636,586, filed on Apr. 19, 2024.

(51) Int. Cl. A01G 23/08

(52) U.S. Cl. CPC A01G 23/08

(57) ABSTRACT

A work vehicle includes a main body, a boom connected to the main body, an arm connected to the boom, and a tool connected to the arm. A tool control system for the work vehicle includes a boom cylinder to extend the boom from and retract the boom to the main body, an arm cylinder to extend the arm from and retract the arm to the boom, a first input device to input intentions of an operator based on manipulation directions of the first input device, and a controller that controls the boom and arm cylinders in coordination with each other in response to the manipulation directions of the first input device. The controller extends the arm cylinder and retracts the boom cylinder in coordination with each other so that the tool moves away from the main body based on manipulation of the first input device in a first direction.

### CROSS-REFERENCE TO RELATED APPLICATIONS

This application claims the benefit of U.S. Provisional Application No. 63/636,586 filed on April 19, 2024. The entire disclosure of U.S. Provisional Application No. 63/636,586 is hereby incorporated herein by reference.

### BACKGROUND

### Field of the Invention

The present disclosure generally relates to a tool control system for a work vehicle. More specifically, the present disclosure relates to a tool control system for a work vehicle, which facilitates extending and/or retracting a tool controlled by an operator.

### Background Information

Work vehicles are used in construction, farming, forestry, etc. Whether used in construction, farming, forestry, etc., work vehicles typically have one or more work implements or tools attached thereto to perform some work. On such a work vehicle, at least one work implement is coupled to the vehicle body and/or chassis. Regardless of the work implement, a work vehicle includes a ground propulsion apparatus that uses tracks or wheels to propel and/or steer the forestry machine. The tracks or wheels also serve to support the main body of the work vehicle. One example of a work vehicle is a forestry work vehicle that is used for logging (e.g., cutting trees and/or transporting felled trees) or various other forestry purposes. One example of a forestry machine is a feller buncher or harvester. On a harvester, the work implement typically includes a feller head with a spinning disc saw used to fell trees. Another possible forestry work implement is a clamp used to pickup and load felled trees.

In the case of a feller buncher or harvester, the feller head is pivotally mounted at the end of an arm. The arm is pivotally mounted to a boom. The boom is pivotally mounted to the vehicle body or chassis. A hydraulic circuit is connected to a boom cylinder, an arm cylinder and a feller head cylinder to control movement of the feller head. The hydraulic circuit is also connected to the saw blade to rotate the saw blade. An operator controls the movement and operation of the feller head by controlling the hydraulics using multiple operating members such as joysticks as well as other controls such as foot pedals and dash buttons/switches.

Some examples of work vehicles are disclosed in U.S. Patent No. 9,297,148, U.S. Patent No. 7,007,728, U.S. Patent No. 6,763,863, U.S. Patent No. 7,222,444, U.S. Patent No. 10,584,463, and U.S. Patent Application Publication No. 2022/0170234.

### SUMMARY

It has been discovered that controlling a work implement as desired may require simultaneous use of both of the operator’s hands. It has also been discovered that such control can lead to fatigue of the operator, less productive operators and/or difficulty in controlling the work implement especially for less skilled or novice operators.

Therefore, one object of the present disclosure is to provide a tool control system for a work vehicle, with which the operator can extend and/or retract the work equipment of work vehicle such as a forestry machine using a single control lever. This can reduce operator fatigue, allow operators to be more productive, and reduce difficulty in operation by less experienced operators.

Additionally, it has been discovered that changing the existing control of a work implement may require additional and/or more complicated parts such as valves, linkages and/or sensors.

Therefore, another object of the present disclosure is to provide a tool control system for a work vehicle, with which there are no mechanical linkages, additional hydraulic valving and/or sensors required beyond the standard configuration of a single directional valve for each cylinder.

It has been further discovered that because changing existing controls may require additional and/or more complicated parts such as valves, linkages and/or sensors, changing existing controls can be complicated and not possible with existing work vehicles.

Therefore, another object of the present disclosure is to provide a tool control system for a work vehicle, which can be utilized/installed on existing and new work vehicles. This is because a software solution does not require any additional hydraulic valving, cylinders, or sensors. This methodology can be added to any forestry machine that is of the standard feller buncher configuration.

It has been further discovered that work machine coordination for a forestry machine is desirable to both reduce operator fatigue and allow novice operators to increase their production.

Therefore, another object of the present disclosure is to provide a single actuator that the operator controls to control the boom and arm of the work equipment allowing it to be extended and retracted along a plane parallel to the ground.

As is apparent from the above objects, one purpose of this disclosure is to improve coordinated work equipment. The nature of this disclosure is such that it can be solely software based and not require any additional hardware to be installed on the machine.

In view of the state of the known technology and in accordance with a first aspect of the present disclosure, a tool control system for a work vehicle is provided. The work vehicle includes a main body, a boom pivotably connected to the main body, an arm pivotably connected to the boom, and a tool pivotally connected to the arm. The tool control system includes a boom cylinder configured to extend the boom from the main body and retract the boom to the main body, an arm cylinder configured to extend the arm from the boom and retract the arm to the boom, a first input device usable to input intentions of an operator based on manipulation directions of the first input device, and a controller configured to control the boom cylinder and the arm cylinder in coordination with each other in response to the manipulation directions of the first input device. The controller is configured to extend the arm cylinder and to retract the boom cylinder in coordination with each other so that the tool moves away from the main body based on manipulation of the first input device in a first direction.

In accordance with second to fourteenths aspects of the present disclosure, the tool control system of the first aspect may further include the feature(s) of any one or more of those recited in the second to fourteenth claims filed herewith, respectively, if practical.

In accordance with a fifteenth aspect of the present disclosure, a work vehicle may include the tool control system according to any one of the preceding aspects or any of the following aspects.

In view of the state of the known technology and in accordance with a sixteenth aspect of the present disclosure, a tool control system for a work vehicle is provided. The work vehicle includes a main body, a boom pivotably connected to the main body, an arm pivotably connected to the boom, and a tool connected to the arm. The tool control system includes a boom cylinder configured to extend the boom from the main body and retract the boom to the main body, an arm cylinder configured to extend the arm from the boom and retract the arm to the boom, a first input device usable to input intentions of an operator based on manipulation directions of the first input device, a second input device usable to input intentions of the operator based on manipulation directions of the second input device, and a controller configured to control the boom cylinder and the arm cylinder in coordination with each other in response to the manipulation directions of the first input device. The controller is configured to change movement of the boom cylinder in response to the manipulation directions of the second input device.

In accordance with seventeenth to twentieth aspects of the present disclosure, the tool control system of the sixteenth aspect may further include the feature(s) of any one or more of those recited in the seventeenth to twentieth claims filed herewith, respectively, if practical.

It will be apparent to those having ordinary skill in the art from this disclosure that the above aspect are merely examples of illustrative embodiment(s) of this invention and do not limit the scope of this invention.

Also, other objects, features, aspects and advantages of the disclosed work vehicle will become apparent to those skilled in the work vehicle field from the following detailed description, which, taken in conjunction with the annexed drawings, discloses exemplary embodiments of the work vehicle.

### BRIEF DESCRIPTION OF THE DRAWINGS

Referring now to the attached drawings which form a part of this original disclosure:

FIG. 1 is a front-left side perspective view of a work vehicle including a tool control system in accordance with an embodiment;

FIG. 2 is a left side elevational view of a work vehicle in accordance with another embodiment;

FIG. 3 is a front elevational view of the work vehicle illustrated in FIG. 2;

FIG. 4 is an operator view of a first (right or left) control lever of the work vehicle, with buttons (first or second user inputs) to show an example button program layout;

FIG. 5 is an operator view of a second (left or right) control joystick of the work vehicle, with buttons (second or first user inputs) to show an example button program layout;

FIG. 6 is an enlarged elevation view of a dash panel of a dashboard of the work vehicle, with a mode switch switchable between manual mode and coordinated mode and other programmable switches (buttons);

FIG. 7 is a simplified schematic illustration of a machine controller of the work vehicle;

FIG. 8 is a diagrammatic view of the tool control system of the work vehicle, illustrating an extending work equipment operation in a manual boom and arm control mode;

FIG. 9 is a diagrammatic view of the tool control system of the work vehicle, illustrating a retract work equipment operation in the manual boom and arm control mode;

FIG. 10 a diagrammatic view of the tool control system of the work vehicle, illustrating an extending work equipment operation in a coordinated boom and arm control mode;

FIG. 11 a diagrammatic view of the tool control system of the work vehicle, illustrating an extending work equipment operation (override down) in the coordinated boom and arm control mode;

FIG. 12 a diagrammatic view of the tool control system of the work vehicle, illustrating an extending work equipment operation (override up) in the coordinated boom and arm control mode;

FIG. 13 a diagrammatic view of the tool control system of the work vehicle, illustrating a retract work equipment operation in the coordinated boom and arm control mode;

FIG. 14 a diagrammatic view of the tool control system of the work vehicle, illustrating a retract work equipment operation (override up) in the coordinated boom and arm control mode;

FIG. 15 a diagrammatic view of the tool control system of the work vehicle, illustrating a retract work equipment operation (override down) in the coordinated boom and arm control mode;

FIG. 16A and FIG. 16B show a flow chart illustrating the control logic of the tool control system during the extending work equipment operations illustrated in FIGS. 10-12; and

FIG. 17A and FIG. 17B show a flow chart illustrating the control logic of the tool control system during the retract work equipment operations illustrated in FIGS. 13-15.

### DETAILED DESCRIPTION OF THE EMBODIMENT(S)

Selected embodiments will now be explained with reference to the drawings. It will be apparent to those skilled in the art from this disclosure that the following description of the embodiments is provided for illustration only and not for the purpose of limiting the invention as defined by the appended claims and their equivalents.

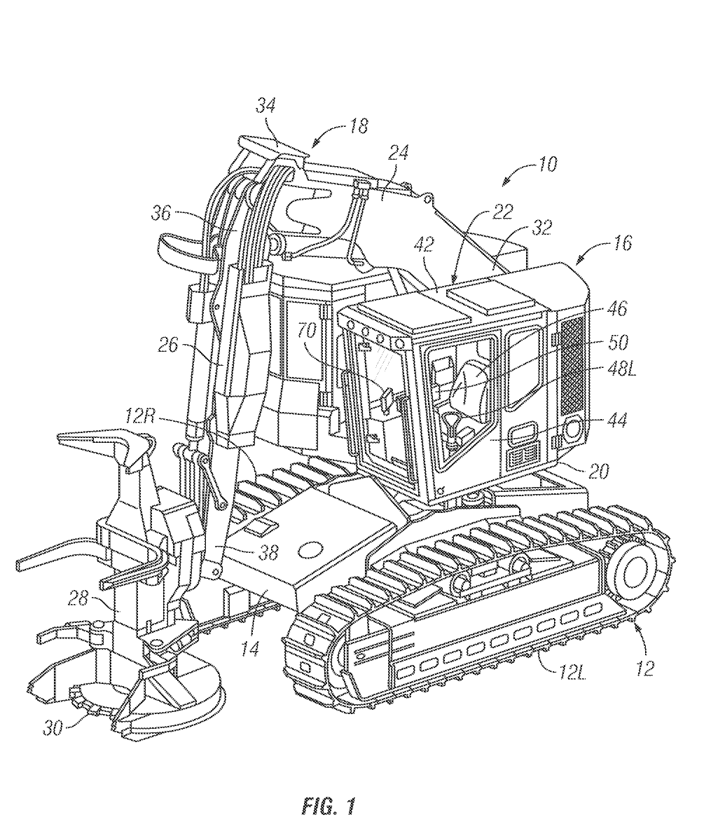

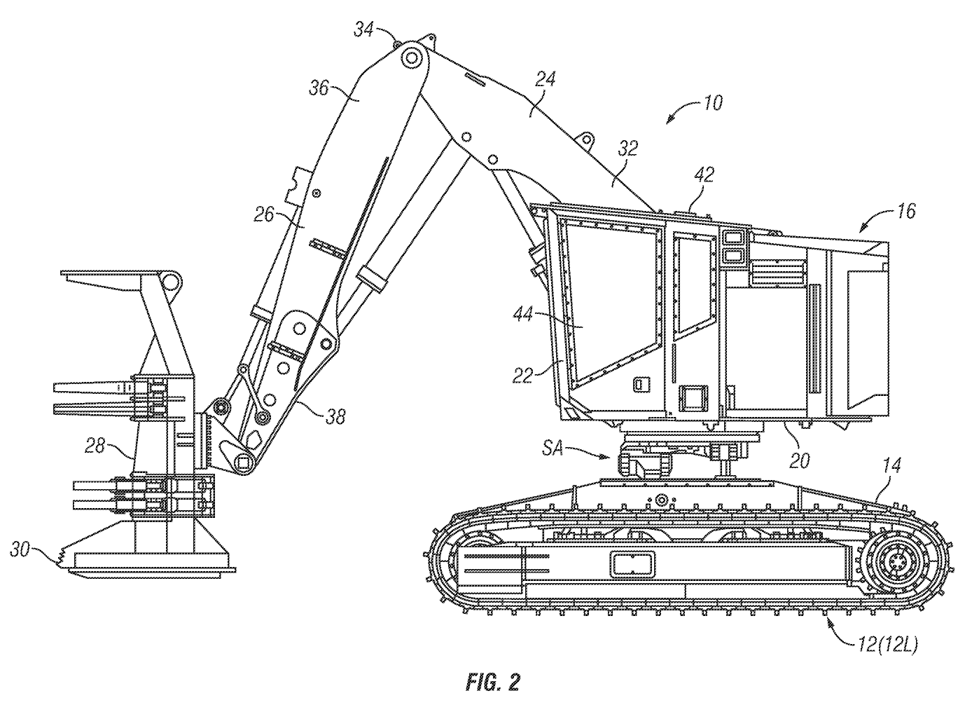

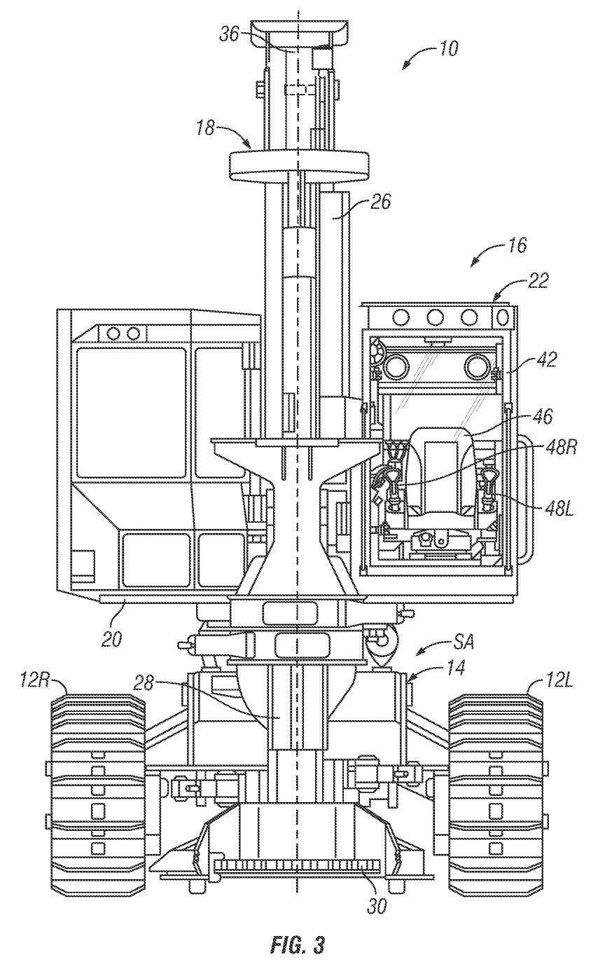

Referring initially to FIGS. 1-3, a work vehicle 10 is respectively illustrated. As explained below, the work vehicle 10 has improved operation of a work implement 18 mounted thereto. In the illustrated embodiments, the work vehicle 10 is a tree harvester, such as a short tail tracked harvester. While it will be apparent to those skilled in the art from this disclosure that certain aspects may be particularly beneficial in the illustrated tree harvester, it will also be apparent that many of the aspects of the work vehicle 10 can be applied to other types of forestry machines. For example, the present disclosure may be applicable to wheeled forestry machines, long tailed tree harvesters, or any other forestry machine in which it is desired for a work implement to be easily operated by the operator. Moreover, it will be apparent that many of the aspects of the work machine 10 can be applied to other types of work machines (e.g., construction and/or farming) in which it is desired for a work implement to be easily operated by the operator.

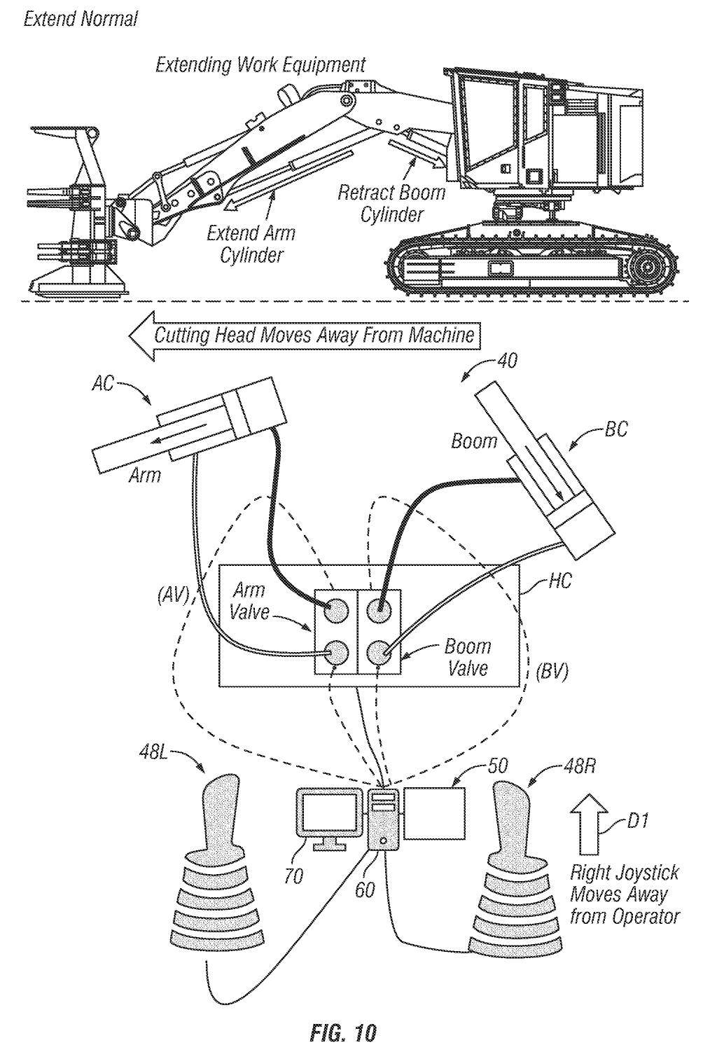

In the illustrated embodiments, the work machine 10 includes a ground propulsion apparatus 12, a chassis 14, a vehicle body 16, and the work implement 18. The work implement 18 is controlled by a control system 40 in accordance with the present disclosure. Movement and operation of the work implement 18 are controlled by the control system 40. The operator controls the control system 40, as explained in more detail below. The elements of the control system 40 are comprehensively illustrated in FIGS. 8-15 and will be explained below in more detail.

In the illustrated embodiments, the ground propulsion apparatus 12 has a pair of tracks 12L and 12R used to propel and maneuver the work vehicle 10 in a conventional manner. However, it will be apparent to those skilled in the work vehicle field from this disclosure that the present disclosure is also applicable the wheeled work vehicles in which the tracks are replaced by wheels or some other means of moving the work vehicle 10 along the ground. The ground propulsion apparatus 12 supports the chassis 14, which supports the vehicle body 16. The vehicle body 16 is pivotally supported by and attached to the ground propulsion apparatus 12 via the chassis 14. The work implement 18 is movably attached to the vehicle body 16. The vehicle body 16 includes a deck 20 on which an operator cab 22 is disposed and from which an operator can operate the work vehicle 10.

The ground propulsion apparatus 12 of the illustrated embodiments includes an undercarriage and other conventional parts that enable the work vehicle 10 to move along a ground surface. In the illustrated embodiments, the ground propulsion apparatus 12 includes the left or first track 12L and the right or second track 12R. The first and second tracks 12L and 12R are arranged to contact the ground surface. The first and second tracks 12L and 12R are driven by, for example, a hydraulic motor (not shown). In the illustrated embodiments, the work vehicle 10 is a short tail tracked harvester in that the rear end of the vehicle body 16 does not extend beyond the first and second tracks. In other words, a rearmost portion of the vehicle body 16 is positioned forward with respect to a rearmost end of the first and second tracks 12L and 12R when the vehicle body 16 is oriented facing forward without a swing angle.

As shown in FIG. 1, the chassis 14 is basically a frame to which the ground propulsion apparatus 12 is attached. The chassis 14 is supported with respect to the ground surface by the ground propulsion apparatus 12 and serves to support the vehicle body 16 with respect to the ground propulsion apparatus 12. More specifically, the chassis 14 is configured to support a swing apparatus SA that supports the vehicle body 16 (e.g., the deck 20). The swing apparatus SA includes a swing bearing and a swing motor (not shown). In the illustrated embodiments, the swing motor, the swing bearing, and the vehicle body 16 are coupled together such that the vehicle body 16 can be rotated about a vertical swing axis by the swing motor. The vehicle body 16 is supported on the swing apparatus SA such that the vehicle body 16 is swingably mounted to the chassis 14 about the vertical swing axis. Although the illustrated embodiments are provided with the swing apparatus SA, the disclosure is not limited to a work vehicle that includes a swing apparatus. The vehicle body 16 can be non-rotatable or fixed with respect to the chassis 14. In addition, in the illustrated embodiments, the swing apparatus SA is a leveling swing apparatus SA. However, it will be apparent to those skilled in the art from this disclosure that the swing apparatus SA can be non-leveling.

Referring still to FIGS. 1-3, in the illustrated embodiments, the work implement 18 includes a boom 24, an arm 26 and an attachment or work tool 28. In the illustrated embodiments, the work tool 28 is a harvester head/attachment that includes a high-speed disc saw 30. The boom 24 has a vehicle attachment end 32 and an arm attachment end 34. The vehicle attachment end 32 is movably attached to at least one of the chassis 14 and the vehicle body 16. The arm attachment end 34 attached to the arm 26. The arm 26 has a boom attachment end 36 and a tool attachment end 38. The boom attachment end 36 is pivotally coupled to the arm attachment end 34. The work tool 28 is coupled to the tool attachment end 38 of the arm 26. A pivotal connection attaches the boom 24 to the arm 26 in a conventional manner, such that the work vehicle 10 can be operated with the boom 24 and the arm 26 in a plurality of orientations. The boom 24 and the arm 26 are operated using a conventional hydraulic system.

The vehicle body 16 includes the cab 22 as well as numerous other conventional components such as an engine compartment containing an engine, a main hydraulic housing containing the main vehicle hydraulics, and a counterweight supported on the deck 20. The deck 20 is a strong rigid plate shaped member constructed of for example steel plate material. The deck 20 can be constructed of multiple parts. The deck 20 is attached to the swing apparatus SA. In addition, the work implement 18 is movable attached to the deck 20 adjacent the cab 22.

The operator cab 22 includes a box shaped structure 42, a door 44, an operator's seat 46, a left (first or second) control lever or joystick 48L, a right (second or first) control lever or joystick 48R and a dashboard 50 including various operating members useable by the operator to operate the work vehicle 10. In the illustrated embodiments, left and right control joysticks 48L and 48R are illustrated. However, these are merely two examples of possible control levers in accordance with the present disclosure. It will be apparent to those skilled in the art from this disclosure that other types of control levers can be used as needed and/or desired. The box shaped structure 42 is constructed of rigid plate material and can be constructed of several parts attached to each other. The box shaped structure 42 has various cutouts with windows mounted therein, and a door opening with the door 44 pivotally mounted therein in a conventional manner. The door 44 is openable and closable to allow an operator to enter and exit the cab 22 in a conventional manner.

In the illustrated embodiments, numerous operating members (user inputs) are provided to be operated by hand, and pedal type operating members (not shown) are provided on the floor to be operated by foot. There are no particular limitations on the arrangement and type of operating members provided in the operator cab 22. The foot pedals can be used to control the ground propulsion apparatus 12 to control movement of the overall position of the forestry machine 10 itself over the terrain. The operating members on the dashboard 50 are preferably arranged in positions where they are easy for the operator to access and do not obstruct the operator's field of view. In the illustrated embodiments, as one example, the dashboard 50 is positioned to the right of the operator. In the illustrated embodiment, the operating members on the dashboard 50 are shown as physical buttons, switches, etc. However, it will be apparent to those of ordinary skill in the art that one or more touch screens can be used instead of the physical buttons, switches, etc. or in addition to (i.e., to provide redundant control) the physical buttons, switches, knobs, etc.

Referring now to FIGS. 1-5, the control joysticks 48L and 48R will now be explained in more detail. The control joysticks 48L and 48R are electrically and mechanically identical, except for where they are mounted within the cab 22. The control joysticks 48L and 48R are movable to control various components of the forestry machine 10. In addition, each of the control joysticks 48L and 48R includes a plurality of buttons and a trigger (located behind of the joystick and thus not shown). The joysticks48L and 48R are programmable to control various functions of the forestry machine. In particular, movement directions of each control joysticks 48L and 48R, e.g., front, back left and right, can be programmed so that a certain function is carried out in response to the movement. In addition, the plurality of buttons and a trigger (not shown) on each of the control joysticks 48L and 48R are programmable to carry out certain functions in response to actuation thereof. The joysticks 48L and 48R are merely examples of control joysticks. It will be apparent to those skilled in the art from this disclosure that the control joysticks 48L and 48R can have more or fewer buttons and or triggers and/or the triggers can be eliminated, if needed and/or desired.

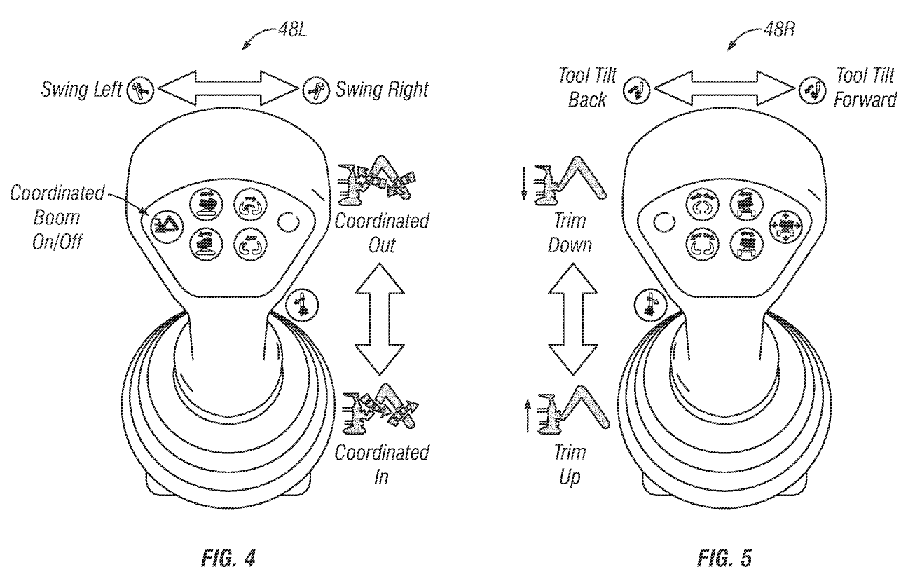

Referring now to FIG. 4, one example of how the left control joystick can be programmed is illustrated. First, one example of movement directions of the control joystick 48L will be discussed. Moving the control joystick 48L forward raises the main boom 24, while moving the control joystick 48L backward lowers the main boom 24. Moving the control joystick 48L left causes the body 16 with the work implement 18 to swing left, while moving the control joystick 48L to the right causes the body 16 with the work implement 18 to swing right. The buttons and trigger can be programmed as follow: Saw Cut ON/OFF, Cab Level Back, Cab level left, Clamp arms open, Clamp Arms Open, Clamp and Accumulator Close, Clamp and Accumulator Open. Clamp arms can be used to grab individual trees for cutting in a conventional manner. The accumulator can be used when cutting multiple trees to accumulate the trees in an accumulator pocket in a conventional manner. The leveling buttons can be used to level the vehicle body 16. Because the work vehicle 10 often operates on uneven terrain, levelling can make it easier for the operator to harvest trees. Two functions have redundant programming in this example. This is not necessary. However, there are enough buttons and triggers so that the control joystick 48L has seven possible programmed functions, even if all might not be needed. It will be apparent that other programming schemes are possible. In fact, the variety of programming schemes is only limited by the preferred button layout of each particular operator.

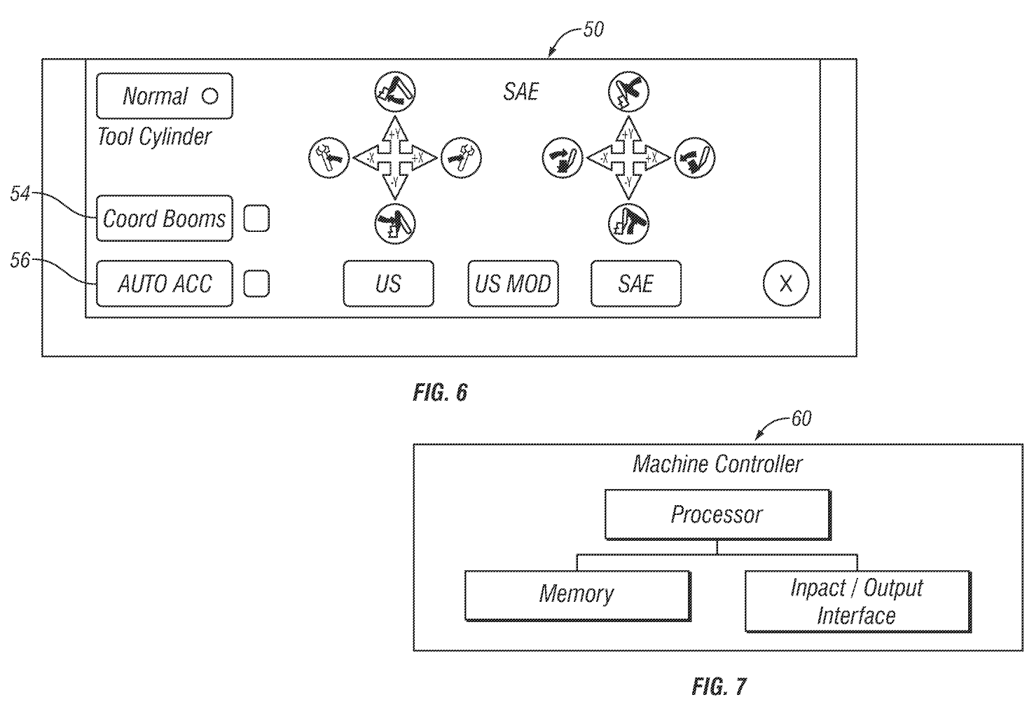

Referring to FIG. 5, one example of how the right control joystick can be programmed is illustrated. First, one example of movement directions of the control joystick 48R will be discussed. Moving the control joystick 48R forward sticks the arm 26 out, while, moving the control joystick 48R backward sticks the arm 26 in. Moving the control joystick 48R left causes the work tool 28 to tilt back, while moving the control joystick 48R to the right causes the work tool 28 to tilt forward. The buttons and trigger can be programmed as follow: Clamp Arms Open, Cab Level Left, Cab level Right, Track Shift, Clamp and Accumulator Open, Clamp Arms Close, G= Clamp Arms Close. Track shift is used when it is desired to move the forestry machine along a linear path, i.e., the track shift button can be used to keep the travel along the desired track in a conventional manner. Two functions have redundant programming in this example. This is not necessary. However, there are enough buttons and triggers so that the control joystick 48R has seven possible programmed functions, even if all might not be needed. It will be apparent that other programming schemes are possible. In fact, the variety of programming schemes is only limited by the preferred button layout of each particular operator. It will be apparent to those skilled in the art from this disclosure that the functions of the left/right control joysticks 48R and 48L can be reversed.

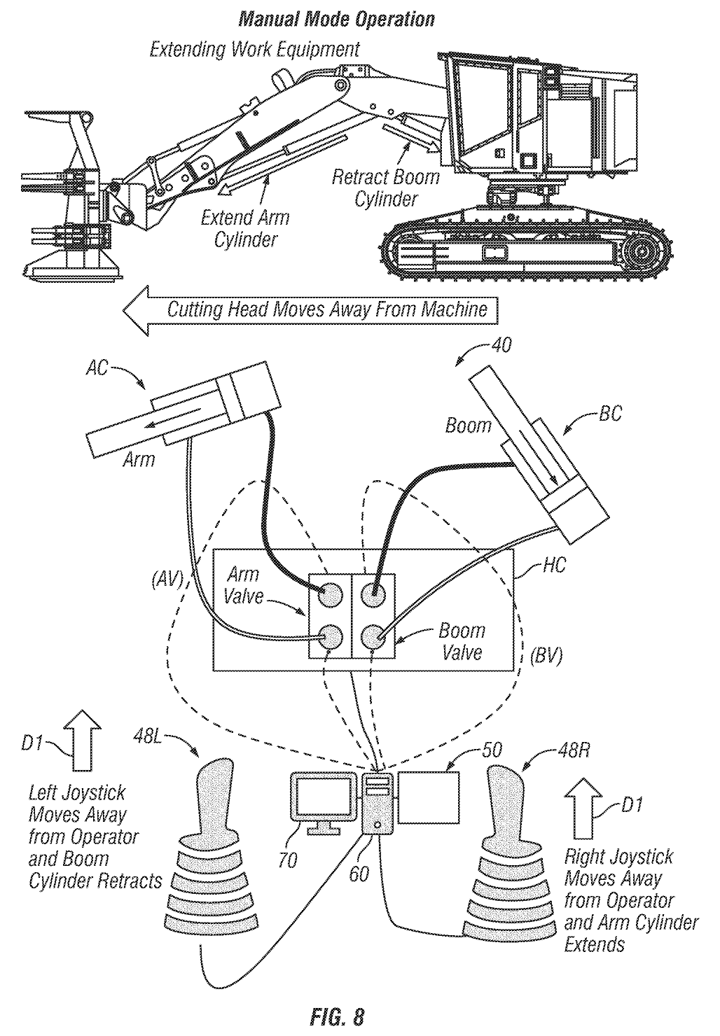

Referring now to FIG. 6, the dashboard 50 will now be explained in more detail. The dashboard 50 includes various conventional controls such as for staring the engine, lights, heating and ventilation, throttle, choke, emergency stop, indicator lights, display(s), etc. in a conventional manner. Since these elements are conventional they will not be discussed and/or illustrated herein. In addition, the dashboard 50 includes a hydraulic arming switch 54, other hydraulic controls and conventional inputs. Moreover, a mode switch button 56 in accordance with the present disclosure may be provided. The illustrated buttons/switches 54 and 56 are merely examples of mode switch and hydraulic arming switch. Alternatively, other buttons/switches on the dashboard 50 can be used, buttons/triggers on the joysticks 48R and 48L can be used, or a mode switching function can be provided within a menu on a screen 70, shown in FIGS. 1-2 and 8-15.

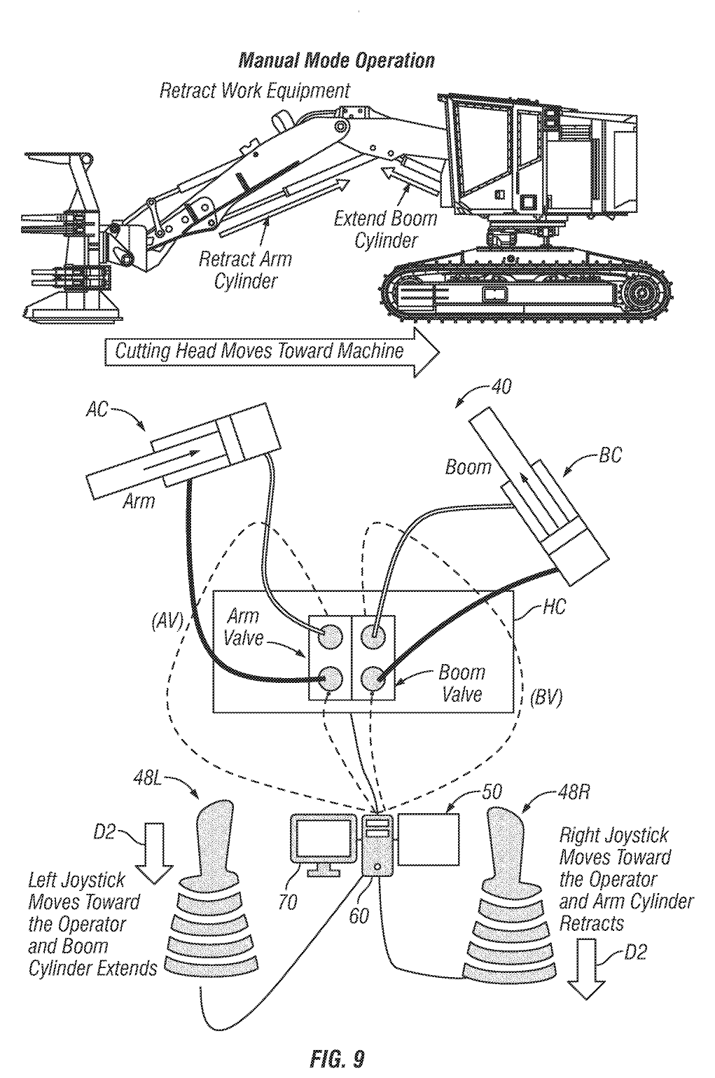

In any case, a convention work vehicle includes the necessary hardware, such as a switch or menu to accomplish mode switching. The engine drives a main hydraulic circuit HC in order to control various features of the forestry machine 10 in a conventional manner. Because the hydraulic circuit HC is conventional, the hydraulic circuit HC will not be discussed and or illustrated in detail herein, except as utilize to control the work implement 18 in accordance with the illustrated embodiment. The hydraulic arming switch 54 arms the main hydraulics of the forestry machine 10 in a conventional manner. In the illustrated embodiment, the boom valve BV and arm valve AV of the conventional hydraulic circuit HC are controlled in accordance with the control system 40 of the present invention. A machine controller 60 (only shown in FIGS. 7-15), as an element of the control system 40, can be disposed behind the dashboard 50 or in any other location where the machine controller 60 can be connected to or communicate with the control joysticks 48L and 48R as well as the parts of the dashboard 50, the parts of the hydraulic circuit HC and the screen 70.

Referring now to FIG. 7, the machine controller 60 in this embodiment is an electronic controller. The electronic controller 60 is preferably a microcomputer or central processing unit (CPU) that includes at least one processor, at least one computer storage device (i.e., computer memory device(s)), and an input/output interface. The input/output interface can receive information from other components including the left and right control levers 48L and 48R and the dashboard 50, and send operating signals to other components including the boom valve BV and the arm valve AV. The electronic controller 60 is formed of one or more semiconductor chips that are mounted on a circuit board. The electronic controller 60 can be one or more integrated circuits having firmware for causing the circuitry to complete the activities described herein. Of course, any number of other analog and/or digital components capable of performing the below described functionality can be provided in place of, or in conjunction with the below described electronic controller 60. The term “electronic controller” as used herein refers to hardware that executes a software program, and does not include a human.

The memory is any computer storage device or any non-transitory computer-readable medium with the sole exception of a transitory, propagating signal. For example, the memory can include nonvolatile memory and volatile memory, and can includes a ROM (Read Only Memory) device, a RAM (Random Access Memory) device, a hard disk, a flash drive, etc. The memory or computer storage device is configured to store settings, programs, data, calculations and/or results of the processor(s) of the electronic controller 60.

The user operable input(s), user inputs and are not limited to the ones shown and described herein, and can include, for example, a button or buttons, a switch or switches, a lever or levers, a dial or dials, a knob or knobs, and/or one or more touch screens. For example, the saw button A could be a physical switch that either latches or toggle, instead of a button. The user operable input(s) can be mounted on a suitable portion of the vehicle as explained and/or illustrated herein. The term “user operable input” is a device that is manually operated by a person. The term “user operable input” as used herein do not include a human.

Although in the illustrated embodiment, the user inputs, the electronic controller 60, and the boom valve BV and the arm valve AV are illustrated as electrically connected (wired) together for communication, other communication device(s) can be used. A communication device is a hardware device capable of transmitting an analog or digital signal over a communication wire, or wirelessly. One example of a communication device is a computer Modem, which is capable of sending and receiving a signal to allow computers to talk to other computers over the telephone. Other examples of communication devices include a NIC (network interface card), Wi-Fi devices, and access points.

The term “wireless communication device” as used herein includes a receiver, a transmitter, a transceiver, a transmitter-receiver, and contemplates any device or devices, separate or combined, capable of transmitting and/or receiving wireless communication signals, including shift signals or control, command or other signals related to some function of the component being controlled. The wireless communication signals can be radio frequency (RF) signals, ultra-wide band communication signals, or Bluetooth® communications or any other type of signal suitable for short range wireless communications. The hydraulic control valves could also use a hydraulic pilot signals to shift the start solenoids. Another type of electrical signal that could be used is CAN.

FIGS. 1-7 discussed above basically illustrate conventional components of the work vehicle 10. However, the machine controller 60, control joysticks 48L and 48R, and dashboard button(s) are programmed to be operated by the tool control system 40 as illustrated in FIGS. 8-17B in accordance with the present invention, which will now be explained.

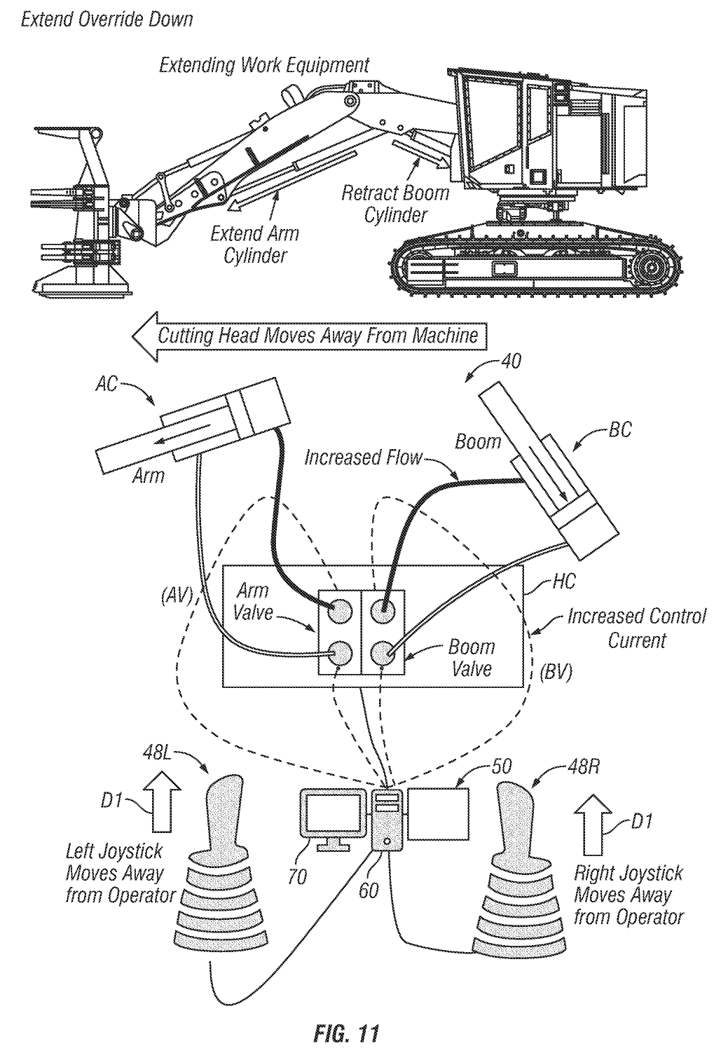

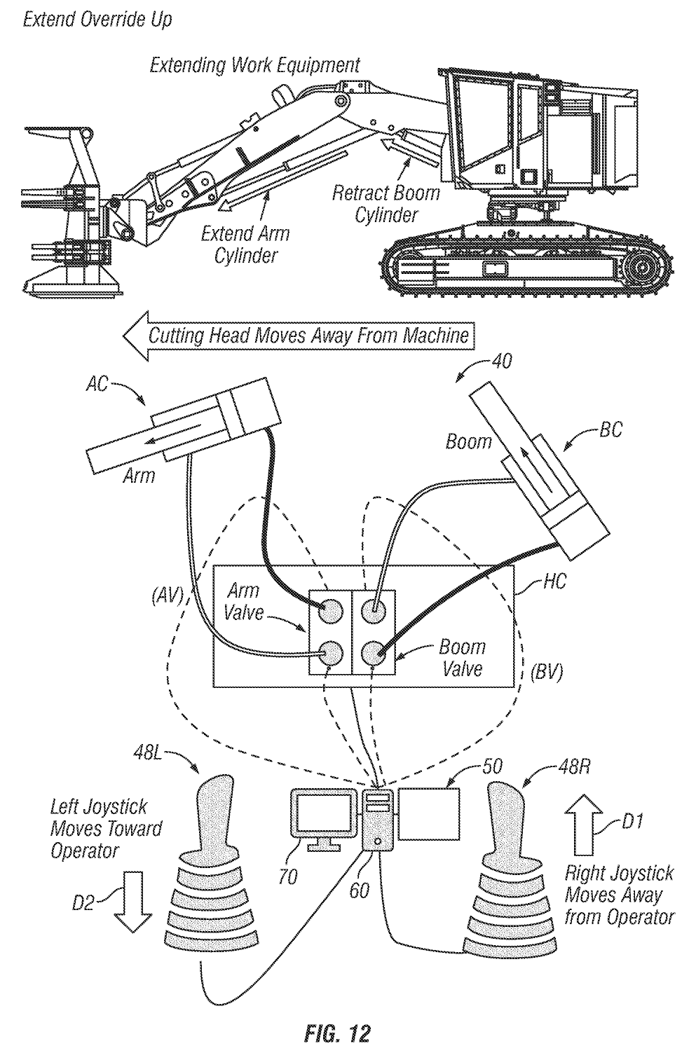

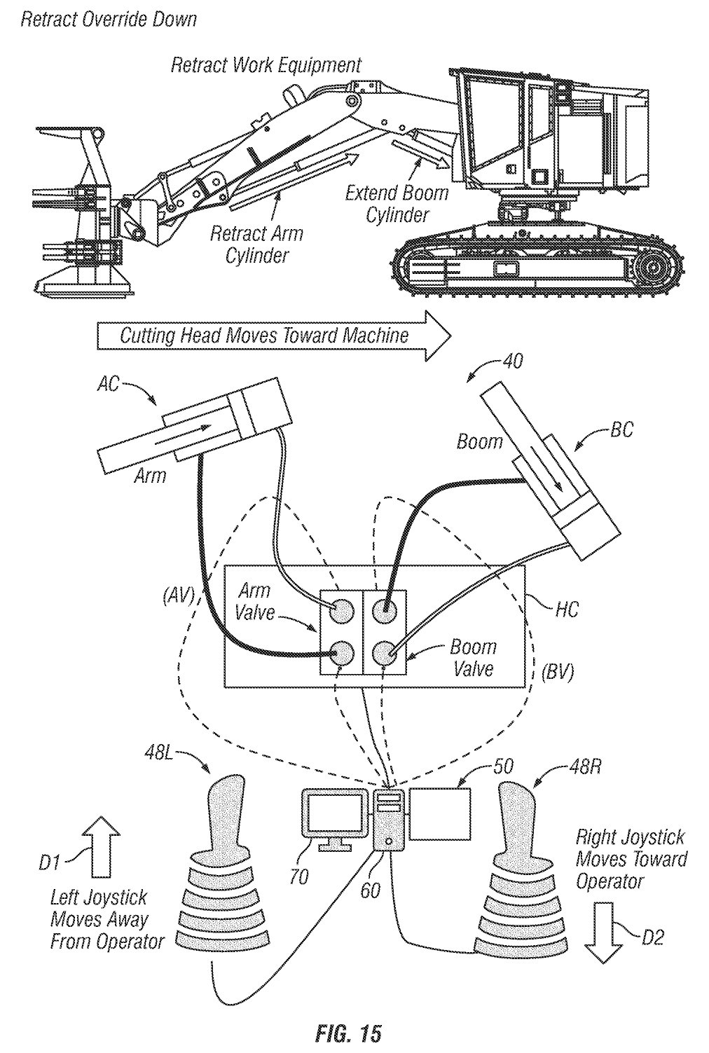

Referring now to FIGS. 8-17B, the tool control system 40 that is programmed in accordance with the present invention will now be explained in more detail. The tool control system 40 may be operated in a manual mode or a coordinated mode. The manual mode is a conventional mode in which both joysticks 48L and 48R are used simultaneously by the operator to control movement of the work implement 18, as shown in FIGS. 8-9. The coordinated mode is introduced in this disclosure, and is illustrated in FIGS. 10-17B. The coordinated mode is operable during work implement 18 extension (FIGS. 10-12) and work implement 18 retraction (FIGS. 13-15). Switching between a manual mode and a coordinated mode is also introduced in this disclosure. Switching between the coordinated mode and the manual mode is also introduced in this disclosure. The coordinated mode allows the operator to use only one of the joysticks, e.g., 48R, to control movement of the work implement 18, but also allows an override feature in which the other of the joysticks, e.g., 48L, can be used to override the normal control using the only one of the joysticks, e.g., 48R.

The tool control system 40 basically includes a boom cylinder BC configured to extend the boom 24 from the main body 16 and retract the boom 24 to the main body 16, an arm cylinder AC configured to extend the arm 26 from the boom 24 and retract the arm 26 to the boom 24, at least one of first and second input devices usable to input intentions of an operator based on manipulation directions of the first input device, and the machine controller 60 configured to control the boom cylinder BC and the arm cylinder AC in coordination with each other in response to the manipulation directions of the at least one input device. In the illustrated embodiment, a pair of input devices (the first and second input devices) are the left and right control joysticks 48L and 48R. For example, in FIGS. 8-15 the right control joystick 48R is programmed as the first input device. However, the left control joystick 48L could be the first input device instead of the right control joystick 48R. Each of the cylinders BC and AC is conventional and includes a rod attached to a piston, which is received in a cylinder member. The cylinder member is attached to one member and the rod is attached to the other to cause movement between the two members in a conventional manner.

The controller 60 is configured to extend the arm cylinder AC and to retract the boom cylinder BC in coordination with each other so that the tool 28 moves away from the main body 16 based on manipulation of the first input device 48R in a first direction D1. The controller 60 is configured to retract the arm cylinder AC and to extend the boom cylinder BC in coordination with each other so that the tool 28 moves toward the main body 16 based on manipulation of the first input device 48R in a second direction D2. In the illustrated embodiment, the second direction D2 is opposite to the first direction D1. Also, in the illustrated embodiment, the first direction D1 is a forward direction and the second direction D2 is a rearward direction. Various configurations for the first and second input devices are possible. However, as mentioned above, in the illustrated embodiment, the first and second input device are control levers (e.g., joysticks) such as the control levers 48L and 48R. Either of the control levers 48R and 48L can be considered the first or second.

In the coordinated control mode (FIGS. 10-15), the controller 60 is configured to control the boom cylinder BC and the arm cylinder AC in coordination with each other such that the tool 28 moves along a plane P. This control can be accomplished using only one of the control levers 48L and 48R. The inclination of the plane P can be controlled (adjusted) by the operator. As one example, the plane P is parallel to the ground G upon which the work vehicle 10 is located. However, an inclination of the plane P relative to a horizontal plane or the ground is adjustable. In particular, the second input device, e.g., second control lever 48L, is usable to input intentions of the operator based on manipulation directions of the second input device 48L.

Specifically, the controller 60 is configured to change movement of one of the arm cylinder AC and the boom cylinder BC based on manipulation of the second input device 48R, while the arm cylinder AC is being extended and the boom cylinder BC is being retracted in coordination with each other so that the tool 28 moves away from the main body 16 based on manipulation of the first input device 48R in the first direction D1. More specifically, the controller 60 is configured to change movement of the boom cylinder BC based on manipulation of the second input device 48L, while the arm cylinder AC is being extended and the boom cylinder BC is being retracted in coordination with each other so that the tool 28 moves away from the main body 16 based on manipulation of the first input device 48R in the first direction D1. Similar control during retraction is also possible as explained below. During such control, manipulation of the second input device 48L up to a predetermined manipulation level causes a change of movement of the one of the arm cylinder AC and the boom cylinder BC, and manipulation of the second input device 48L past the predetermined manipulation level causes only movement of the one of the arm cylinder AC and the boom cylinder BC. One example of a predetermined manipulation amount is 25%. However, other thresholds are possible. For example, 20% and 30% are other examples.

Referring to FIGS. 8-9, the manual mode will now be explained in more detail. In the manual mode there are two common controls, manual mode extension (FIG. 8) and manual mode retraction (FIG. 9).

In the manual mode extension operation, to extend the cutting tool 28 away from the operator, the operator must move the left joystick 48L away from his body to retract the boom cylinder BC. At the same time, the operator must move the right joystick 48R away from his body to extend the arm cylinder AC. Thus, in the manual mode extension operations, the operator simultaneously moves the left and right joysticks 48L and 48R to extend the work implement 18.

When this occurs, the left joystick 48L will send a signal to the controller 60 of the control system 40 based on the operator's input. The controller 60 of the control system 40 will take this signal and then send a signal to the boom valve BV. The boom valve BV will shift, allowing hydraulic oil to come from the pump of the hydraulic circuit HC and be sent to the rod side of the boom cylinder BC, retracting the piston of boom cylinder BC. At the same time, the right joystick 48R will send a signal to the controller 60 of the control system 40 based on the operator's input. The controller 60 of the control system 40 will take this signal and then send a signal to the arm valve AV. The arm valve AV will shift, allowing hydraulic oil to come from the pump of the hydraulic circuit HC and be sent to the base side of the arm cylinder AC, extending the piston of the arm cylinder AC. It should be noted the control scheme could be varied between joysticks 48L and 48R. For example, the left joystick 48L could control the arm cylinder AC and the right joystick 48R could control the boom cylinder BC. This is determined by the operators preference.

Referring now to FIGS. 10-15, the coordinated mode will now be explained in more detail. In the coordinated control mode there are also basically two common controls, coordinated control extension (FIGS. 10-12) and coordinated control retraction (FIGS. 13-15). Work machine coordination for a forestry machine is desirable to both reduce operator fatigue and allow novice operators to increase their production. To achieve this, a single actuator the operator controls (for example the control joystick 48R) can be used to control the boom cylinder BC and arm cylinder AC of the work implement 18 allowing it to be extended and retracted along a plane P parallel to the ground (G) with simplified operator movements (a single actuator rather than simultaneous use of a pair of actuators). In the illustrated embodiment the plane P and ground (G) are illustrated as horizontal in FIGS. 10 and 13 for simplicity. However, it will be apparent to those having ordinary skill in the art from this disclosure that the plane P and ground G can be inclined in the case of use on a hill or mountain side. Moreover, it will be apparent to those having ordinary skill in the art from this disclosure that the plane P can be adjusted to be angled relative to the ground G and ground G, as explained below.

In coordinated control, when the operator moves the primary control lever (joystick) 48R along one axis, the software will send separate control currents to the valves BV and AV that control the boom and the arm. As understood from FIG. 10, one control current will shift the boom valve BV for the boom cylinder BC to allow the boom cylinder BC to retract while another control current will shift the arm valve AV for the arm cylinder AC to allow the arm cylinder AC to extend. This will move the work implement 18 and cutting tool 28 away from the machine. Likewise, as understood from FIG. 13 when the operator moves the primary control lever 48R along an opposite direction along the same axis, a control current will shift the boom valve BV for the boom cylinder BC to allow the boom cylinder BC to extend while also sending a control current to the arm valve AV to allow the arm cylinder AC to retract. This will move the work implement 18 and the cutting took 28 back toward the machine.

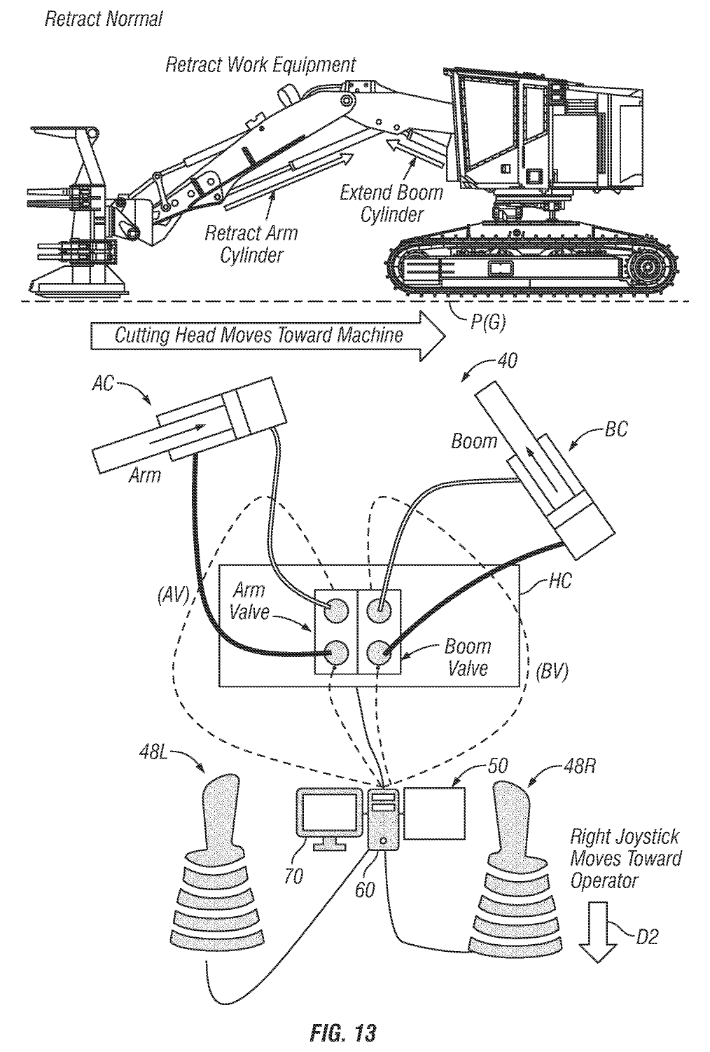

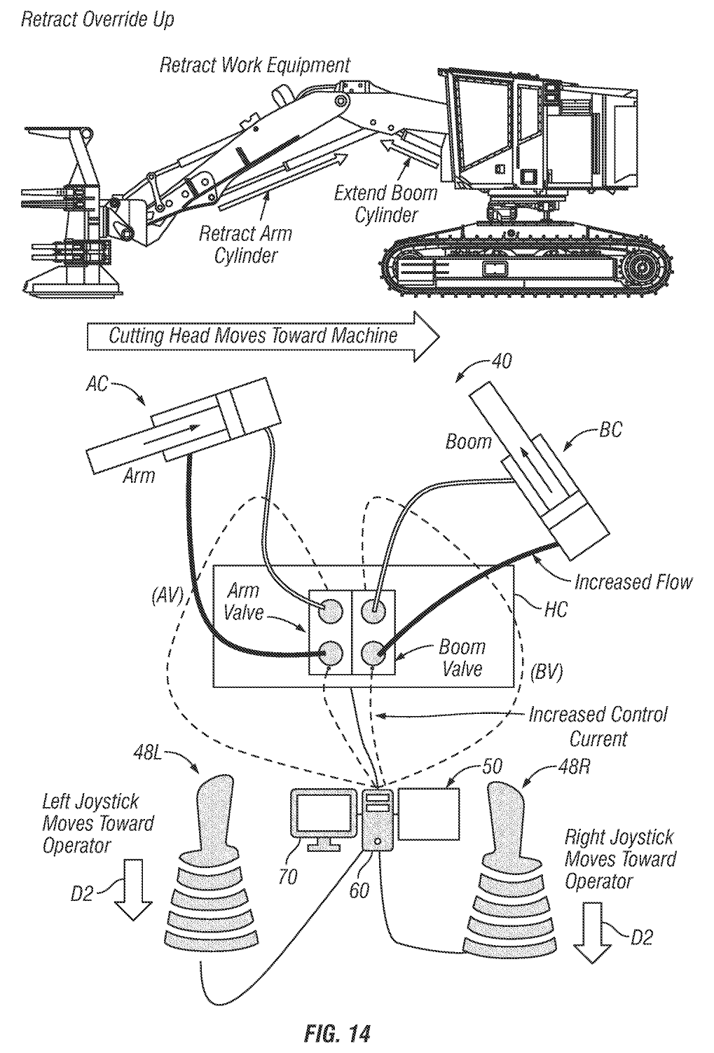

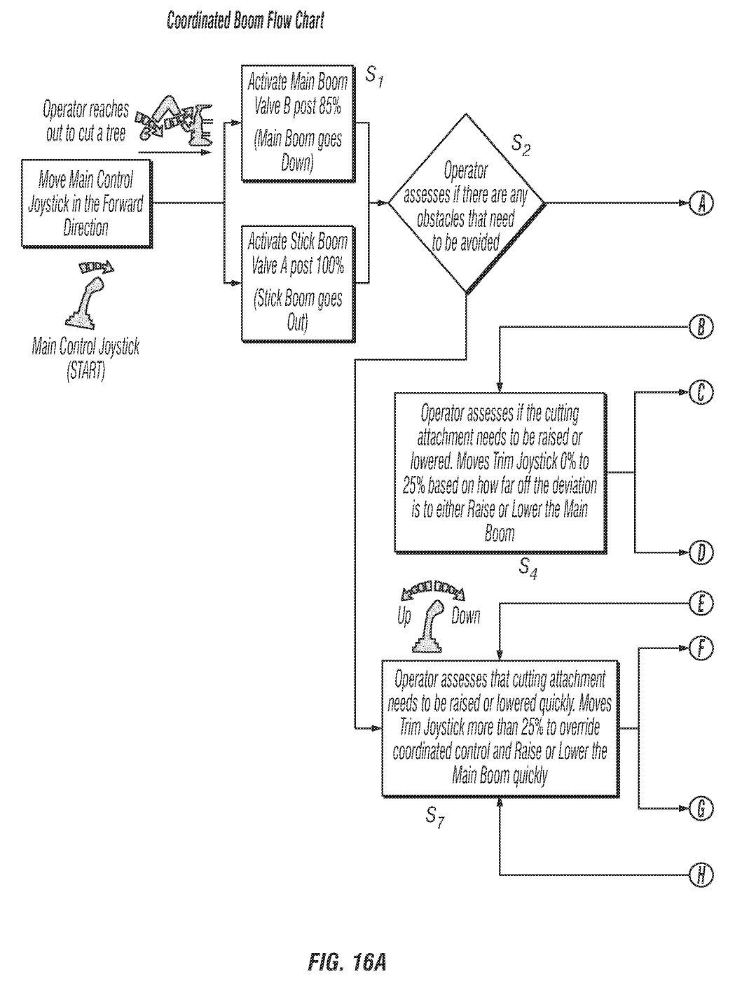

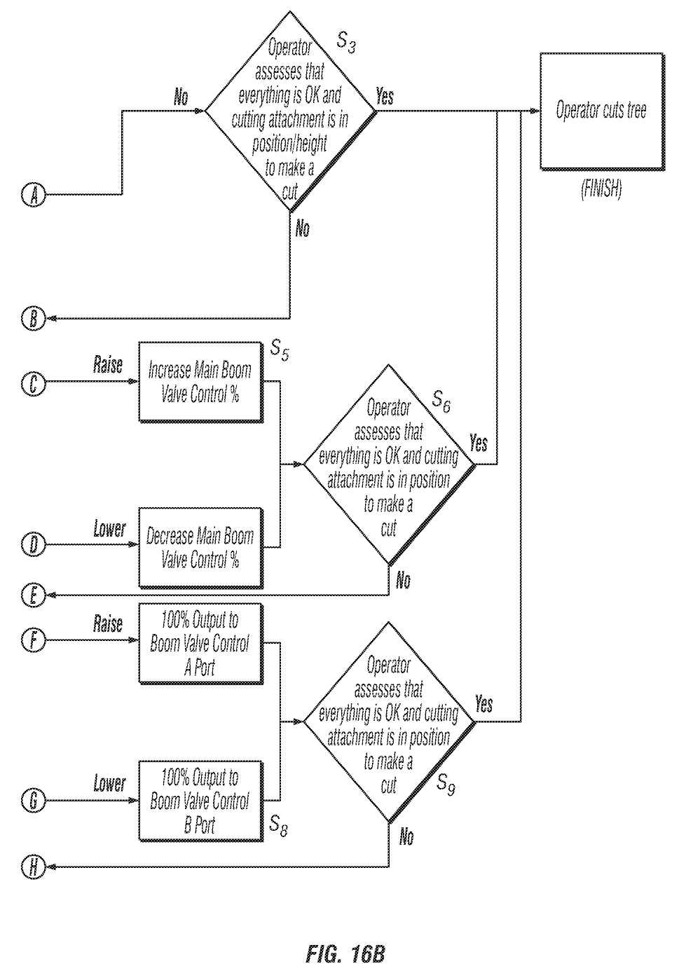

In the coordinated control, an override function could be provided as best understood from FIGS. 11-12 (extension override) and FIGS. 14-15 (retraction override). There may be instances where the operator needs to adjust the height of the cutting tool 28 as it extends or retracts. The operator has the ability to increase or decrease the height of the cutting tool 28 by means of a second joystick, e.g., 48L. When the second joystick 48L is manipulated in the direction of the primary joystick 48R, current is sent to the boom valve BV to increase the boom cylinder BC speed in the given direction. See FIGS. 11 and 14. The second joystick 48L can be moved in the opposite direction of the primary joystick 48R to move the boom cylinder BC in the opposite direction. See FIGS. 12 and 15. In this manner, there are trim functions for each of the four functions, extension override down (FIG. 11), extension override up (FIG. 12), retraction override up (FIG. 14), and retraction override down (FIG. 15) in addition to the normal extension operation (FIG. 10 and the normal retraction operation (FIG. 13).

These settings can facilitate a maximum work equipment speed to be set. In other words, it can be possible for the operator to move and adjust the work implement 18 more quickly and efficiently. The ability to adjust these settings is preferred to match the cylinder speeds between the boom cylinder BV and arm cylinder AC during their motion because the cylinders are different in bore diameter, rod diameter, and stroke. Additionally, the arm valve AV and boom valve BV sections may have different configurations that would change their output characteristics for a give control current.

In addition to the above four trimming functions, extension override down (FIG. 11), extension override up (FIG. 12), retraction override up (FIG. 14), and retraction override down (FIG. 15), the operator also has the ability to quickly turn coordination off to allow for standard (manual) machine control configuration (FIGS. 8-9). That is, the boom cylinder BC and arm cylinder AC will be controlled with separate control levers 48R and 48L when not in the coordination mode. The manual mode can be selected and used by an operator if desired, for example, if an operator prefers traditional operation as shown in FIGS. 8-9. However, even if the operator prefers the coordinated mode of FIGS. 10-15, the manual mode of FIGS. 8-9 can be activated.

Normally in the coordinated mode, if the second control lever 48L is moved, one of the four trimming functions will occur. However, if the second control lever 48L is moved more drastically, the tool control system 40 will turn off the coordinated control of FIGS. 10-15 and activate the manual mode in FIGS. 8-9. In particular, the controller 60 is configured to change movement of one of the arm cylinder AC and the boom cylinder (BC) based on manipulation of the second input device 48L, while the arm cylinder AC is being extended and the boom cylinder BC is being retracted in coordination with each other so that the tool 28 moves away from the main body 16 based on manipulation of the first input device 48R in a first direction D1 (FIGS. 11-12). Likewise, the controller 60 is configured to change movement of one of the arm cylinder AC and the boom cylinder (BC) based on manipulation of the second input device 48L, while the arm cylinder AC is being retracted and the boom cylinder BC is being extended in coordination with each other so that the tool 28 moves away from the main body 16 based on manipulation of the first input device 48R in a first direction D2 (FIGS. 14-15). This type of trimming control occurs if the operator manipulates the second input device 48L up to a predetermined manipulation level, and will cause a change of movement of the one of the arm cylinder AC and the boom cylinder BC (e.g., boom cylinder BC), without changing the movement of the other (e.g., arm cylinder AC).

However, manipulation of the second input device 48L past the predetermined manipulation level causes different control. For example, after movement beyond the predetermined level, the manual mode can be activated, movement of the other of the arm cylinder AC and boom cylinder can be stopped (causing the work vehicle to only move the one of the arm cylinder AC and the boom cylinder BC) and 100% of the boom valve BV and arm valve AV can be sent to the one having changed. On example of a predetermined movement amount is 25% of the total possible overall movement from the rest position. While the predetermined movement amount can be more or less, e.g., 20%, 30%, or 35%, it is preferably less than 50%.

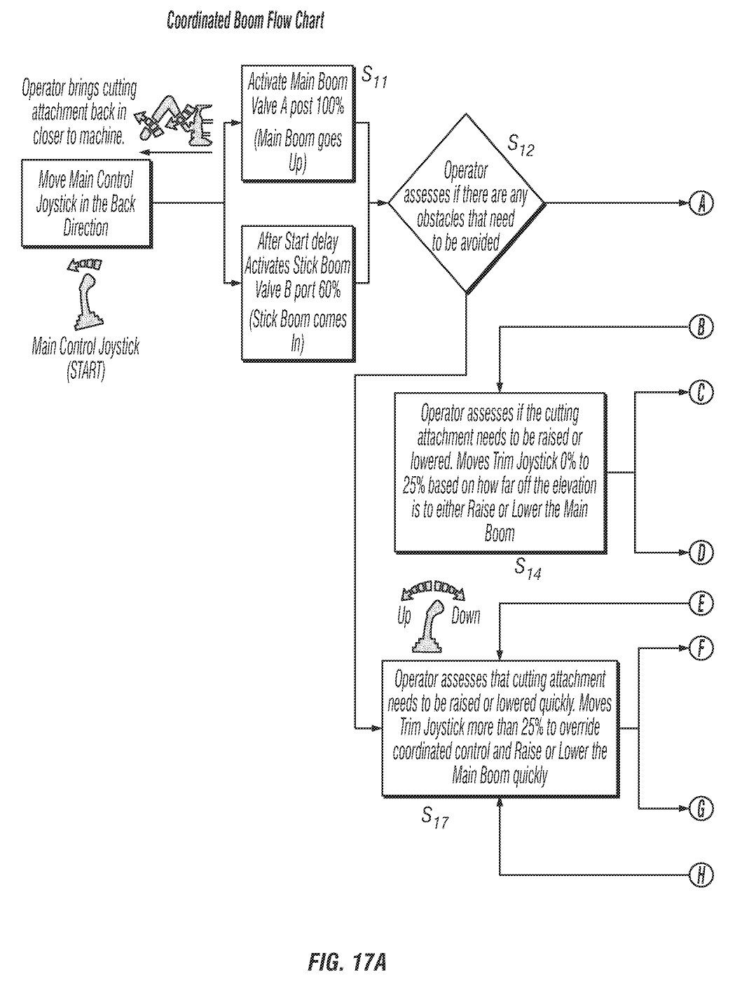

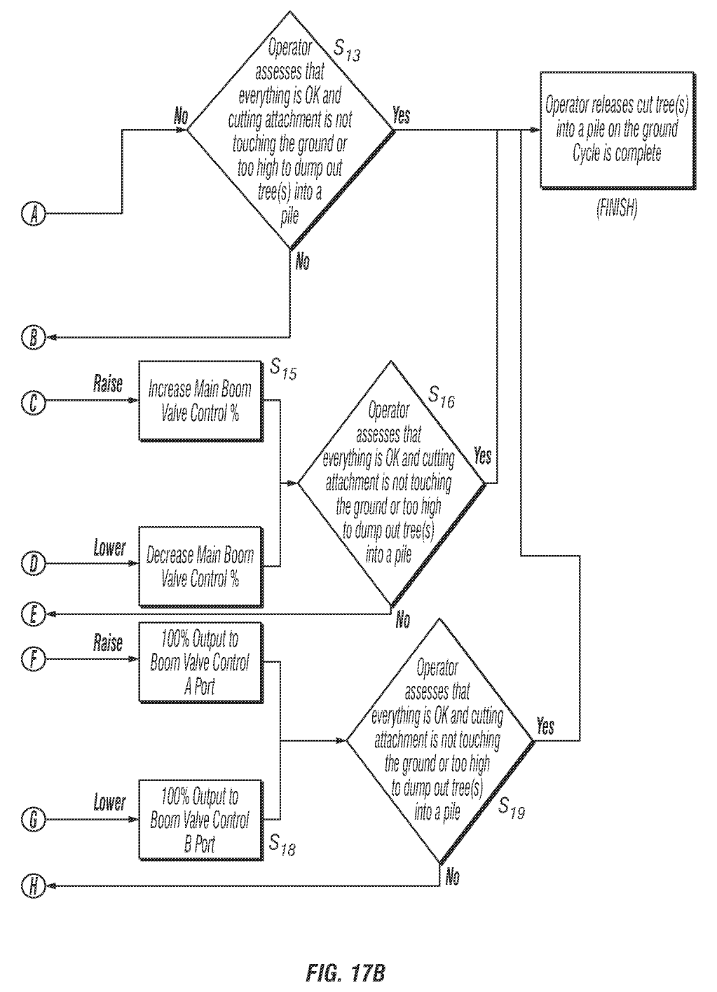

Referring now to FIGS. 16A and 16B and FIGS. 17A and 17B), the control logic of coordinated control extension (FIG. 16A and FIG. 16B) and coordinated control retraction (FIG. 17A and FIG. 17B) will now be explained.

In FIG. 16A and FIG. 16B, extension in the coordinated mode is illustrated. To start a cutting operation an operator performs the operation of FIG. 16A and FIG. 16B. To START, the operator moves the joystick 48R forward the extend the work implement 18 toward the tree to be cut. In step S1, the boom valve BV is activated in port B to 85% and the arm valve AV is activated in Port A to 100% to extend the work implement 18 toward the tree to be cut. These percentages are set according to the bore and stroke of the valves, and thus, these percentages are merely examples of one preferred arrangement. Next at set S2 the operator assesses if there are any obstacles that need to be avoided. If it is determined NO in step S2 the logic proceeds to step S3. In step S3, the operator assesses if everything is OK and the attachment is in the proper position/height to cut a tree. If step S3 determines YES then the control logic proceeds to the FINISH and cuts the tree.

If step S3 determines NO, then the control logic proceeds to step S4. In step S4 the operator assesses whether the cutting attachment needs to be raised or lowered as it is moving toward the tree to be cut and moves the joystick 48L according to whether the tool needs to be raised or lowered. Depending on which direction the operator moves the joystick 48L in step S4, the boom control valve will be adjusted as shown in step S5 and then proceed to step S6. At step S6 the operator assesses if everything is OK and the attachment is in the proper position to cut a tree. If step S6 determines YES then the control logic proceeds to the FINISH and cuts the tree. If step S6 determines NO, then the control logic proceeds to step S7.

At step S7, the operator assesses whether the cutting attachment needs to be raised or lowered quickly, and moves the joystick 48L more than the predetermined amount (e.g., 25%) in the appropriate direction to raise or lower the cutting head quickly and moves to step S8. The coordinated control is overridden and then at step S8 the boom valve is controlled for 100% to port A or B as shown in step S8. After step S8 the logic proceeds to step S9. At step S9, the operator assesses if everything is OK and the attachment is in the proper position to cut a tree. If step S9 determines YES then the control logic proceeds to the FINISH and cuts the tree. If step S9 determines NO, then the control logic proceeds back to step S7 to further move the joystick 48L.

In FIG. 17A and FIG. 17B, retraction in the coordinated mode is illustrated. To bring the tool back after cutting a tree an operator performs the operation of FIG. 17A and FIG. 17B. To START, the operator moves the joystick 48R rearward the retract the work implement 18 toward machine. In step S11, the boom valve BV is activated in port A to 100% and the arm valve AV is activated in Port B to 60% after a short delay, to retract the work implement 18 holding the tree back toward the machine. These percentages are set according to the bore and stroke of the valves, and thus, these percentages are merely examples of one preferred arrangement. By this control, the short delay permits the tool 28 to be raised slightly before retraction. The time period of the delay is programmable, for example at 0.2 or 0.3 seconds. Therefore, the amount of lift before retraction is adjustable. Of course, other time intervals are possible. However, the examples here are preferred examples. Therefore, the controller 60 is further configured to control at least one of arm cylinder AC and the boom cylinder BC to lift the feller head 28 upward after completing a cut and starting movement of the first input device 48R in the second direction D2 before the tool 28 moves toward the main body 16 based on manipulation of the first input device 48R in the second direction D2. An amount of time after starting movement of the first input device 48R in the second direction D2 before the tool moves toward the main body based on manipulation of the first input device in the second direction is programmable.

Next at set S12 the operator assesses if there are any obstacles that need to be avoided. If it is determined NO in step S12 the logic proceeds to step S13. In step S13, the operator assesses if everything is OK and the attachment is not touching the ground or too high to dump the tree(s) into a pile. If step S13 determines YES then the control logic proceeds to the FINISH and the operator releases the cut tree(s) into a pile. If step S13 determines NO, then the control logic proceeds to step S14. In step S14 the operator assesses whether the cutting attachment needs to be raised or lowered as it is moving toward the machine and moves the joystick 48L according to whether the tool needs to be raised or lowered. Depending on which direction the operator moves the joystick 48L in step S14, the boom control valve will be adjusted as shown in step S15 and then proceed to step S16. At step S16 the operator assesses if everything is OK and the attachment is not touching the ground or too high to dump the tree(s) into a pile. If step S16 determines YES then the control logic proceeds to the FINISH and the operator releases the cut tree(s) into a pile. If step S16 determines NO, then the control logic proceeds to step S17.

At step S17, the operator assesses whether the cutting attachment needs to be raised or lowered quickly, and moves the joystick 48L more than the predetermined amount (e.g., 25%) in the appropriate direction to raise or lower the cutting head quickly and moves to step S18. The coordinated control is overridden and then at step S18 the boom valve is controlled for 100% to port A or B as shown in step S18. After step S18 the logic proceeds to step S19. At step S19, the operator assesses if everything is OK and the attachment is not touching the ground or too high to dump the tree(s) into a pile. If step S19 determines YES then the control logic proceeds to the FINISH and the operator releases the cut tree(s) into a pile. If step S19 determines NO, then the control logic proceeds back to step S17 to further move the joystick 48L.

With arrangements described in this disclosure, the operator can configure the machine to his or her liking. The configuration can be altered by the operator for either the left or right hand control, it can be turned off at any time with a control button placed on the handle to do certain machine functions to aide in maneuvering the machine on un-prepared surfaces. There is also the ability to change the control pattern from full coordinated movement of the work equipment to having the control be in one direction; that is controlled motion out and no control bringing the work equipment towards the machine.

Many parts of the work vehicle are conventional components that are well known in the work vehicle field. Since these components are well known in the work vehicle field, these structures will not be discussed or illustrated in detail herein, except as related to the disclosure set forth in the following claims.

As used herein, the following directional terms “forward, rearward, above, downward, vertical, horizontal, below and transverse” as well as any other similar directional terms refer to those directions of a work vehicle on a level surface. Accordingly, these terms, as utilized to describe the present disclosure should be interpreted relative to a work vehicle equipped with the present disclosure. The terms of degree such as “substantially”, “about” and “approximately” as used herein mean a amount of deviation of the modified term such that the end result is not significantly changed.

While only selected embodiments have been chosen to illustrate the present invention, it will be apparent to those skilled in the work vehicle field from this disclosure that various changes and modifications can be made herein without departing from the scope of the invention as defined in the appended claims. Furthermore, the foregoing descriptions of the embodiments according to the present disclosure are provided for illustration only, and not for the purpose of limiting the invention as defined by the appended claims and their equivalents. Thus, the scope of the invention is not limited to the disclosed embodiments.

What is claimed is:

1. A tool control system for a work vehicle including a main body, a boom pivotably connected to the main body, an arm pivotably connected to the boom, and a tool pivotally connected to the arm, the tool control system comprising:
a boom cylinder configured to extend the boom from the main body and retract the boom to the main body;
an arm cylinder configured to extend the arm from the boom and retract the arm to the boom;
a first input device usable to input intentions of an operator based on manipulation directions of the first input device; and
a controller configured to control the boom cylinder and the arm cylinder in coordination with each other in response to the manipulation directions of the first input device,
the controller being configured to extend the arm cylinder and to retract the boom cylinder in coordination with each other so that the tool moves away from the main body based on manipulation of the first input device in a first direction.

2. The tool control system according to claim 1, wherein
the controller is further configured to retract the arm cylinder and to extend the boom cylinder in coordination with each other so that the tool moves toward the main body based on manipulation of the first input device in a second direction.

3. The tool control system according to claim 2, wherein
the second direction is opposite to the first direction.

4. The tool control system according to claim 3, wherein
the first input device is a control lever.

5. The tool control system according to claim 3, wherein
the first direction is a forward direction and the second direction is a rearward direction.

6. The tool control system according to claim 2, wherein
the tool includes a feller head, and
the controller is further configured to control at least one of arm cylinder and the boom cylinder to lift the feller head upward after completing a cut and starting movement of the first input device in the second direction before the tool moves toward the main body based on the manipulation of the first input device in the second direction.

7. The tool control system according to claim 6, wherein
an amount of time after starting movement of the first input device in the second direction before the tool moves toward the main body based on the manipulation of the first input device in the second direction is programmable.

8. The tool control system according to claim 1, wherein
the controller is further configured to control the boom cylinder and the arm cylinder in coordination with each other such that the tool moves along a plane.

9. The tool control system according to claim 8, wherein
the plane is parallel to the ground upon which the work machine is located.

10. The tool control system according to claim 8, wherein
an inclination of the plane is adjustable.

11. The tool control system according to claim 1, further comprising:
a second input device usable to input intentions of the operator based on manipulation directions of the second input device,
the controller being configured to change movement of one of the arm cylinder and the boom cylinder based on manipulation of the second input device, while the arm cylinder is being extended and the boom cylinder is being retracted in coordination with each other so that the tool moves away from the main body based on manipulation of the first input device in a first direction.

12. The tool control system according to claim 11, wherein
the controller is further configured to change movement of the boom cylinder based on manipulation of the second input device, while the arm cylinder is being extended and the boom cylinder is being retracted in coordination with each other so that the tool moves away from the main body based on manipulation of the first input device in a first direction.

13. The tool control system according to claim 11, wherein
the manipulation of the second input device up to a predetermined manipulation level causes a change of movement of the one of the arm cylinder and the boom cylinder, and
manipulation of the second input device past the predetermined manipulation level causes only movement of the one of the arm cylinder and the boom cylinder.

14. The tool control system according to claim 13, wherein
the second input device is a control lever.

15. A work vehicle comprising:
a main body;
a boom pivotably connected to the main body;
an arm pivotably connected to the boom;
a tool connected to the arm; and
a tool control system including
a boom cylinder configured to extend the boom from the main body and retract the boom to the main body;
an arm cylinder configured to extend the arm from the boom and retract the arm to the boom;
a first input device usable to input intentions of an operator based on manipulation directions of the first input device; and
a controller configured to control the boom cylinder and the arm cylinder in coordination with each other in response to the manipulation directions of the first input device,
the controller being configured to extend the arm cylinder and to retract the boom cylinder in coordination with each other so that the tool moves away from the main body based on manipulation of the first input device in a first direction.

16. A tool control system for a work vehicle including a main body, a boom pivotably connected to the main body, an arm pivotably connected to the boom, and a tool connected to the arm, the tool control system comprising:
a boom cylinder configured to extend the boom from the main body and retract the boom to the main body;
an arm cylinder configured to extend the arm from the boom and retract the arm to the boom;
a first input device usable to input intentions of an operator based on manipulation directions of the first input device;
a second input device usable to input intentions of the operator based on manipulation directions of the second input device; and
a controller configured to control the boom cylinder and the arm cylinder in coordination with each other in response to the manipulation directions of the first input device,
the controller being configured to change movement of the boom cylinder in response to the manipulation directions of the second input device.

17. The tool control system according to claim 16, wherein
the controller is further configured to selectively change one of a retraction speed and an extension speed of one of the boom cylinder and the arm cylinder in response to the manipulation directions of the second input device.

18. The tool control system according to claim 16, wherein
the control unit is configured to control the boom cylinder and the arm cylinder in coordination with each other so that the tool selectively moves away from and towards the main body along a plane in response to manipulations of the first input device.

19. The tool control system according to claim 18, wherein
the controller is further configured to selectively change one of a retraction speed and an extension speed of one of the boom cylinder and the arm cylinder in response to the manipulation directions of the second input device while the first input device is manipulated to extend or retract the tool.

20. The tool control system according to claim 19, wherein
manipulation of the second input device up to a predetermined manipulation level causes a change of one of the retraction speed and the extension speed of one of the boom cylinder and the arm cylinder, and
manipulation of the second input device past the predetermined manipulation level causes the primary input device to only cause movement of and the second input device to only cause movement of the boom cylinder.
